(19) United States
(12) Patent Application Publication
(10) Pub. No.: US 2019/0180062 A1
(43) Pub. Date: Jun. 13, 2019

(54) WIRELESS TAG READING APPARATUS AND WIRELESS TAG READING METHOD

(71) Applicant: TOSHIBA TEC KABUSHIKI KAISHA, Tokyo (JP)

(72) Inventor: Nobuo Murofushi, Shizuoka (JP)

(21) Appl. No.: 16/211,491

(22) Filed: Dec. 6, 2018

(30) Foreign Application Priority Data
Dec. 11, 2017 (JP) 2017-236585

(51) Int. Cl. G06K 7/10; G06K 19/07; G06Q 20/20

(52) U.S. Cl. CPC G06K 7/10366; G06Q 20/208; G06K 19/0723

(57) ABSTRACT

A radio wave reception unit (radio wave receiving means) receives a response signal of an RFID tag (wireless tag) with respect to signals of a first frequency and a second frequency different from each other transmitted by a radio wave transmission unit (radio wave transmitting means). Then, a phase difference calculation unit (phase difference calculating means) calculates a phase difference between a plurality of response signals received by the radio wave reception unit. The information determination unit (information determining means) selects an RFID tag from which the identification number (identification information) is to be read based on the calculated phase difference. Then, the tag information reading unit (tag information reading means) reads the identification number (identification information) registered in the selected RFID tag.

### CROSS-REFERENCE TO RELATED APPLICATION

This application is based upon and claims the benefit of priority from Japanese Patent Application No. 2017-236585, filed on Dec. 11, 2017, the entire contents of which are incorporated herein by reference.

### FIELD

Embodiments described herein relate generally to a wireless tag reading apparatus and a wireless tag reading method.

### BACKGROUND

In the related art, a wireless tag reading apparatus for reading commodity information from a commodity provided with a wireless tag such as a radio frequency identification (RFID) tag or the like is known, which collectively reads the commodity information while the commodity is accommodated in a hermetically sealed storage chamber that shields radio waves.

However, since such a wireless tag reading apparatus requires a dedicated storage chamber for shielding radio waves, there is a problem that the size of the apparatus increases and the cost for constructing the system increases.

### DESCRIPTION OF THE DRAWINGS

FIG. 1 is a perspective view showing an external appearance of a wireless tag reading system according to a first embodiment.

FIG. 2 is a view taken in the direction of arrow A in FIG. 1, and showing a schematic configuration of the wireless tag reading apparatus.

FIG. 3 is a hardware block diagram showing an example of a hardware configuration of the wireless tag reading system.

FIG. 4 is a functional block diagram showing an example of a functional configuration of the wireless tag reading apparatus.

FIG. 5 is a functional block diagram showing an example of a functional configuration of an RFID tag.

FIG. 6 is a view taken in the direction of the arrow A in FIG. 1, and provided for explaining a reading range of the RFID tag.

FIG. 7 is a flowchart showing an example of a flow of a process performed by the wireless tag reading apparatus.

FIG. 8 is a flowchart showing an example of a flow of a process performed by a wireless tag reading apparatus according to a modification example of the first embodiment.

### DETAILED DESCRIPTION

An object of the embodiments is to provide a wireless tag reading apparatus capable of reading identification information registered in a wireless tag in a predetermined region without accommodating the wireless tag in a storage chamber that shields radio waves.

A wireless tag reading apparatus according to one embodiment reads identification information registered in a wireless tag, and includes radio wave transmitting means, radio wave receiving means, phase difference calculating means, information determining means, and tag information reading means. The radio wave transmitting means transmits signals of different frequencies from each other. The radio wave receiving means receives a response signal of the wireless tag which is activated by receiving the signal transmitted by the radio wave transmitting means. The phase difference calculating means calculates a phase difference between a plurality of the response signals received by the radio wave receiving means. The information determining means selects the wireless tag from which the identification information is to be read based on the phase difference calculated by the phase difference calculating means. The tag information reading means reads the identification information registered in the wireless tag selected by the information determining means.

### First Embodiment

This embodiment is an example applied to a wireless tag reading system that reads identification information registered in a wireless tag.

### Description of Schematic Configuration of Wireless Tag Reading Apparatus

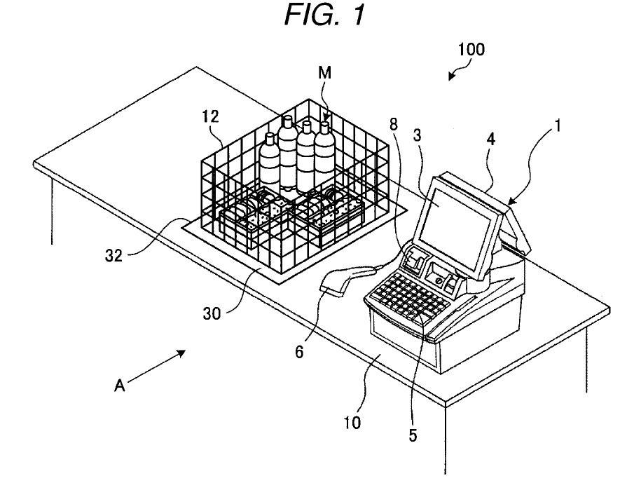

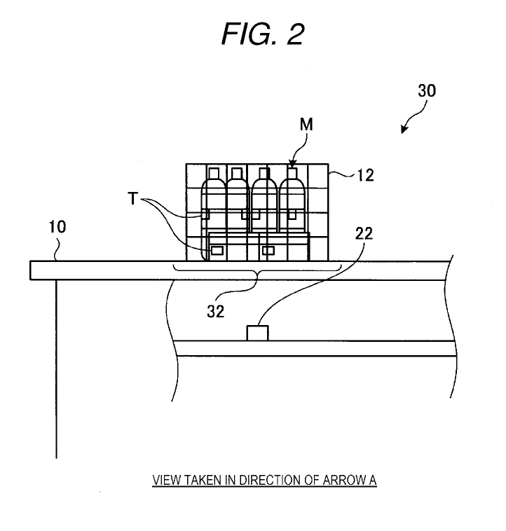

A schematic configuration of the wireless tag reading system 100 will be described with reference to FIG. 1. FIG. 1 is a perspective view showing an external appearance of a wireless tag reading system 100 according to a first embodiment. The wireless tag reading system 100 is installed at a shop such as a supermarket and used for registration processing of commodity information and settlement processing of commodity M purchased by a customer. In particular, the wireless tag reading system 100 reads information such as identification information which uniquely identifies the RFID tag T registered in an RFID tag T (see FIG. 2) attached to commodity, in a non-contact manner by using radio waves, to perform the registration processing of the commodity information of commodity M purchased by the customer. The RFID tag T is an example of a wireless tag.

As shown in FIG. 1, the wireless tag reading system 100 includes a POS terminal 1 placed on a check-out counter 10 and a wireless tag reading apparatus 30. The POS terminal 1 identifies the commodity M purchased by the customer based on the reading result of the RFID tag T read by the wireless tag reading apparatus 30 and performs registration processing for registering commodity information such as commodity code, quantity, price of the commodity M, and so on. Further, the POS terminal 1 performs settlement processing for a payment of the registered commodity M. In addition, the POS terminal 1 controls the operation of the wireless tag reading apparatus 30. The POS terminal 1 includes a clerk-side display 3, a customer-side display 4, a keyboard 5, a barcode reader 6, a receipt printer 8, and the like.

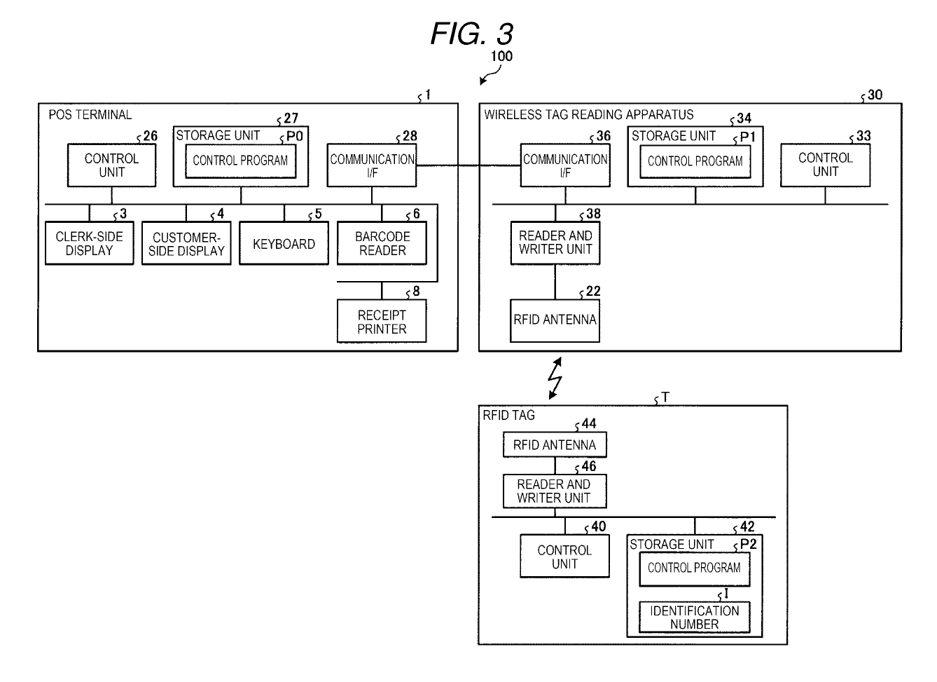

The clerk-side display 3 is attached to an upper part of the POS terminal 1 toward the inside of the check-out counter 10 (toward the clerk side). The clerk-side display 3 displays information such as name and price of the commodity M corresponding to the identification number I (see FIG. 3) read from the RFID tag T. The identification number I is an example of the identification information described above.

The customer-side display 4 is attached to a back side of the clerk-side display 3 toward the outside of the check-out counter 10 (toward the customer-side). The customer-side display 4 displays the commodity information and the like of the commodity M corresponding to the identification number I registered in the RFID tag T read by the wireless tag reading system 100. The identification number I is a commodity code of commodity M, for example.

The keyboard 5 includes a key such as a finish key for declaring the end of the commodity sales data processing of the commodity M purchased by the customer.

The barcode reader 6 optically reads a barcode attached to the commodity M and is arranged to be used at a central portion of the check-out counter 10. The barcode includes information such as commodity code pre-assigned for each commodity M that identifies the type of each commodity M. It should be noted that the RFID tag T and the barcode are attached to each commodity M. Hereinafter, in order to describe the wireless tag reading function which is a characteristic function of the present embodiment, the barcode reading process by the barcode reader 6 will not be described.

The receipt printer 8 prints a receipt after the settlement processing is ended and issues the receipt from a receipt issue opening (not shown in FIG. 1).

The wireless tag reading apparatus 30 reads the identification number I registered in the RFID tag T attached to the commodity M in response to an instruction from the POS terminal 1. It is assumed that the commodity M is put in a shopping basket 12 and placed within a reading range 32 clearly indicated on a table of the check-out counter 10.

Next, a schematic configuration of the wireless tag reading apparatus 30 will be described with reference to FIG. 2. FIG. 2 is a view taken in the direction of the arrow A in FIG. 1, showing a schematic configuration of the wireless tag reading apparatus 30. The wireless tag reading apparatus 30 includes an RFID antenna 22 below the reading range 32 of the check-out counter 10. In response to receiving the instruction from the POS terminal 1, the RFID antenna 22 radiates a radio wave toward the reading range 32. That is, the RFID antenna 22 has directivity in the direction toward the reading range 32.

The radiated radio wave activates the RFID tag T attached to the commodity M in the shopping basket 12. The activated RFID tag T radiates a radio wave as a response signal, which carries an identification number I that uniquely identifies the commodity M to which the RFID tag T is attached.

The RFID antenna 22 receives the response signal radiated by the RFID tag T. Then, the wireless tag reading apparatus 30 reads the identification number I included in the response signal.

### Description of Hardware Configuration of Wireless Tag Reading Apparatus

Next, the hardware configuration of the wireless tag reading system 100 will be described with reference to FIG. 3. FIG. 3 is a hardware block diagram showing an example of a hardware configuration of the wireless tag reading system 100.

As shown in FIG. 3, the wireless tag reading system 100 includes a POS terminal 1, a wireless tag reading apparatus 30, and an RFID tag T.

The POS terminal 1 includes a control unit 26 and a storage unit 27. The control unit 26 controls the overall operation of the wireless tag reading system 100. The control unit 26 includes a central processing unit (CPU) (not shown), a Read Only Memory (ROM), and a Random Access Memory (RAM). The CPU comprehensively controls the operation of the POS terminal 1. The ROM is a storage medium that stores various programs and data. The RAM is a storage medium that temporarily stores various programs and rewrites various data. Then, the CPU executes a control program P0 stored in the storage unit 27 with the RAM as a work area. In this manner, the control unit 26 has a general computer configuration.

The storage unit 27 is a storage device such as a hard disk drive (HDD) or a solid state drive (SSD). The storage unit 27 is connected to the control unit 26 through an internal bus. The storage unit 27 stores the control program P0, a commodity master (not shown), and the like. The control program P0 includes implementing the functions of the operating system and the POS terminal 1. The control program P0 includes realizing the characteristic functions according to the present embodiment. In addition, the storage unit 27 stores the commodity master provided from a shop server (not shown) that manages the POS terminal 1. The commodity master is a master file for each commodity M sold at the shop, which associates the identification number I, the commodity name, and the commodity unit price by which the commodity can be discerned from each other.

The control unit 26 is connected to the keyboard 5, the clerk-side display 3, the customer-side display 4, the barcode reader 6, the receipt printer 8, and the communication I/F (interface) 28 through an internal bus.

Each of the clerk-side display 3, the customer-side display 4, the keyboard 5, the barcode reader 6, and the receipt printer 8 has the functions described above.

The communication I/F 28 communicates with a communication I/F 36 of the wireless tag reading apparatus 30 which will be described below. The communication I/F 28 instructs the wireless tag reading apparatus 30 from the POS terminal 1 to start reading the RFID tag T. In addition, the communication I/F 28 receives the identification number I of the RFID tag T read by the wireless tag reading apparatus 30.

The wireless tag reading apparatus 30 includes a control unit 33, a storage unit 34, a communication I/F 36, a reader and writer unit 38, and an RFID antenna 22.

The control unit 33 controls the operation of the wireless tag reading apparatus 30. The control unit 33 includes a CPU, a ROM, and a RAM (not shown). The CPU comprehensively controls the operation of the wireless tag reading apparatus 30. The ROM is a storage medium that stores various programs and data. The RAM is a storage medium that temporarily stores various programs and rewrites various data. Then, the CPU executes the control program P1 stored in the storage unit 34 with the RAM as a work area. In this manner, the control unit 33 has a general computer configuration.

The storage unit 34 is a storage device such as HDD or SSD. The storage unit 34 is connected to the control unit 33 through an internal bus . The storage unit 34 stores the control program P1 and the like. The control program P1 includes implementing the functions of the operating system and the wireless tag reading apparatus 30. The control program P1 includes realizing the characteristic functions according to the present embodiment.

The control unit 33 is connected to the reader and writer unit 38 and the communication I/F 36 through the internal bus. Further, the reader and writer unit 38 is connected to the RFID antenna 22 described above.

The reader and writer unit 38 controls the operation of the RFID antenna 22 in response to receive an instruction from the control unit 33. More specifically, the reader and writer unit 38 causes the RFID antenna 22 to transmit a high-frequency signal of a predetermined frequency generated by the control unit 33 as a transmit signal. In addition, the reader and writer unit 38 reads the high-frequency signal received by the RFID antenna 22 as a response signal to the transmit signal.

The communication I/F 36 communicates with the communication I/F 28. The communication I/F 36 transmits the identification number I of the RFID tag T read by the wireless tag reading apparatus 30 from the wireless tag reading apparatus 30 to the POS terminal 1. In addition, the communication I/F 36 receives an instruction to start reading the identification number I of the RFID tag T from the POS terminal 1.

The RFID tag T includes a control unit 40, a storage unit 42, an RFID antenna 44, and a reader and writer unit 46.

The control unit 40 controls the operation of the RFID tag T. The control unit 40 includes a CPU, a ROM, and a RAM (not shown). The CPU centrally controls the operation of the RFID tag T. The ROM is a storage medium that stores various programs and data. The RAM is a storage medium that temporarily stores various programs and rewrites various data. Then, the CPU executes the control program P2 stored in the storage unit 42 with the RAM as a work area. In this manner, the control unit 40 has a general computer configuration.

The storage unit 42 is a non-volatile memory device such as a flash memory. The storage unit 42 is connected to the control unit 40 through an internal bus. The storage unit 42 stores the control program P2, the identification number I of the RFID tag T, and the like. The control program P2 includes implementing the function of the RFID tag T. The control program P2 includes realizing the characteristic functions according to the present embodiment.

The control unit 40 is connected to the reader and writer unit 46 and the storage unit 42 through an internal bus. Further, the reader and writer unit 46 is connected to the RFID antenna 44 described above.

The RFID antenna 44 receives the transmit signal transmitted by the RFID antenna 22. In addition, the RFID antenna 44 transmits a response signal including the identification number I of the RFID tag T.

The reader and writer unit 46 controls the operation of the RFID antenna 44 in response to receiving the instruction from the control unit 40. More specifically, the reader and writer unit 46 reads the transmit signal from the wireless tag reading apparatus 30 received by the RFID antenna 44. In addition, the reader and writer unit 46 transmits the response signal including the identification number I of the RFID tag T generated by the control unit 40 from the RFID antenna 44.

### Description of Functional Configuration of Wireless Tag Reading Apparatus

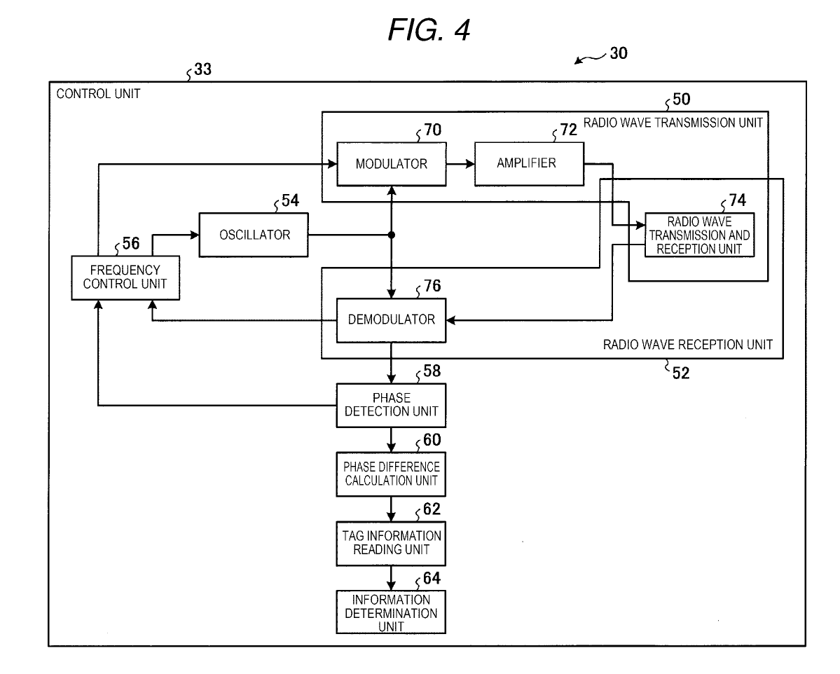

Next, a functional configuration of the wireless tag reading apparatus 30 will be described with reference to FIG. 4. FIG. 4 is a functional block diagram showing an example of a functional configuration of the wireless tag reading apparatus 30.

The control unit 33 of the wireless tag reading apparatus 30 deploys the control program P1 stored in the storage unit 34 (see FIG. 3) described above onto the RAM and operates according to the control program P1, whereby each functional unit shown in FIG. 4 is generated in the RAM. Specifically, the control unit 33 includes a radio wave transmission unit 50, a radio wave reception unit 52, an oscillator 54, a frequency control unit 56, a phase detection unit 58, a phase difference calculation unit 60, a tag information reading unit 62, and an information determination unit 64 as functional units.

The radio wave transmission unit 50 causes the RFID antenna 22 described above to radiate a transmit signal, that is, the high-frequency signal outputted from an amplifier 72 which will be described below, into the air . More specifically, the radio wave transmission unit 50 includes a modulator 70, the amplifier 72, and a radio wave transmission and reception unit 74. The radio wave transmission unit 50 is an example of the radio wave transmitting means. In addition, the transmit signal transmitted by the radio wave transmission unit 50 includes an instruction to execute the RFID tag T receiving the transmit signal.

The modulator 70 converts digital data outputted from the frequency control unit 56, which will be described below, into an analog signal, using for example, an encoding circuit and a filter, and mixes the analog signal and a sinusoidal wave outputted from the oscillator 54 in a mixer circuit, and outputs a high-frequency signal.

The amplifier 72 amplifies the high-frequency signal from the modulator 70 using the amplification circuit and outputs the amplified high-frequency signal. The amplification factor of the high-frequency signal is set according to setting of the reading range of the RFID tag T. Details will be described below. In addition, the amplifier 72 may not be necessarily installed when the power of the high-frequency signal output from the modulator 70 is sufficient to perform wireless communication within a predetermined range.

The radio wave transmission and reception unit 74 causes the RFID antenna 22 to transmit a transmit signal for reading the identification number I of the RFID tag T to the reader and writer unit 38.

More specifically, the radio wave reception unit 52 includes a radio wave transmission and reception unit 74 and a demodulator 76. The radio wave reception unit 52 receives the high-frequency signal propagating through the air as a response signal to the RFID antenna 22, and outputs the received response signal to the demodulator 76. The radio wave reception unit 52 is an example of radio wave receiving means.

The radio wave transmission and reception unit 74 causes the RFID antenna 22 to receive the response signal from the RFID tag T to the reader and writer unit 38. Then, the radio wave transmission and reception unit 74 acquires the response signal received by the RFID antenna 22 through the reader and writer unit 38.

The demodulator 76 synthesizes the high-frequency signal received by the radio wave transmission and reception unit 74 and the output signal of the oscillator 54 using a mixer circuit, for example, and removes frequency components unnecessary for reception by a filter to extract an analog signal. The extracted analog signal is outputted to the phase detection unit 58. In addition, the demodulator 76 digitizes the analog signal using a binarization circuit and outputs the digitized analog signal to the frequency control unit 56 described below.

The oscillator 54 outputs a sinusoidal wave having a stable frequency, using a phase locked loop (PLL) circuit for example, in accordance with an instruction from the frequency control unit 56. The output signal of the oscillator 54 is a carrier wave of a high-frequency signal (radio wave) radiated to the RFID tag T.

The frequency control unit 56 operates when the phase detection unit 58 completes the detection of the phase after completing the demodulation of the high-frequency signal received by the demodulator 76, and instructs the oscillator 54 on the frequency of the sinusoidal wave to be generated. Then, the oscillator 54 generates carrier waves having different frequencies according to the instruction of the frequency control unit 56. The frequency selected by the frequency control unit 56 is set to a frequency within a range of 916.8 MHz to 922.2 MHz, which is a frequency range available based on the Radio Act in Japan, for example.

The phase detection unit 58 detects the phase of the response signal received by the radio wave reception unit 52. In addition, the phase detection unit 58 outputs the detected phase to the frequency control unit 56 described above. The phase detection unit 58 detects the phase of the response signal by detecting, for example, an I signal that is in phase with the transmit signal and a Q signal that is a quadrature phase component with respect to the transmit signal from the response signal. This phase detection method is a known method called orthogonal demodulation (orthogonal detection).

The phase difference calculation unit 60 calculates the phase difference of a plurality of response signals received by the radio wave reception unit 52. The phase difference calculation unit 60 is an example of the phase difference calculating means. For example, the phase difference calculation unit 60 calculates the phase difference between the phase of the first response signal received by the radio wave reception unit 52 with respect to the high-frequency signal having the first frequency transmitted by the radio wave transmission unit 50, and the phase of the second response signal received by the radio wave reception unit 52 with respect to the high-frequency signal having the second frequency different from the first frequency transmitted by the radio wave transmission unit 50.

The tag information reading unit 62 reads the identification number I of the RFID tag T, which is registered in the RFID tag T and included in the response signal received by the radio wave reception unit 52. The tag information reading unit 62 is an example of the tag information reading means.

The information determination unit 64 selects the RFID tag T to be read by the tag information reading unit 62 based on the phase difference calculated by the phase difference calculation unit 60. The information determination unit 64 is an example of the information determining means.

Specifically, the information determination unit 64 selects an RFID tag T as a target to be read, when the phase difference calculated by the phase difference calculation unit 60 for the corresponding response signal is equal to or less than a predetermined threshold.

Although not shown in FIG. 4, the wireless tag reading apparatus 30 also has a function of writing information in the RFID tag T as well as reading the identification number I registered in the RFID tag T. For example, the wireless tag reading apparatus 30 is capable of writing information indicating the completion of the reading of the identification number I to the RFID tag T from which the identification number I is read.

### Description of Functional Configuration of RFID Tag

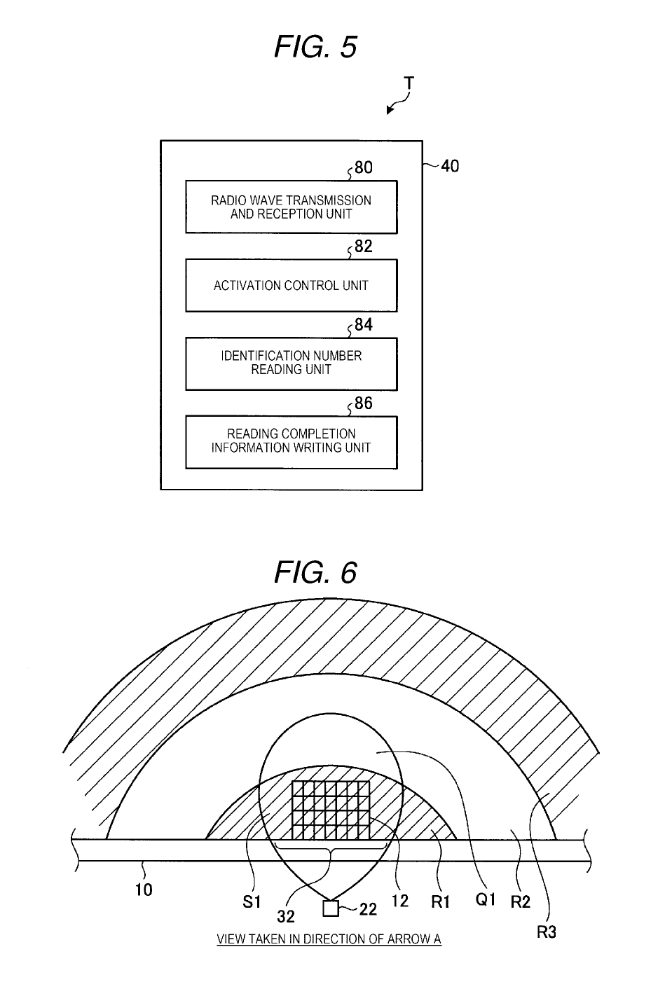

Next, the functional configuration of the RFID tag T will be described with reference to FIG. 5. FIG. 5 is a functional block diagram showing an example of a functional configuration of an RFID tag T.

The control unit 40 of the RFID tag T deploys a control program P2 stored in the storage unit 42 (see FIG. 3) described above onto the RAM and operates according to the control program P2, whereby each functional unit shown in FIG. 5 is generated in the RAM. More specifically, the control unit 40 realizes a radio wave transmission and reception unit 80, an activation control unit 82, an identification number reading unit 84, and a reading completion information writing unit 86 as functional units.

The radio wave transmission and reception unit 80 causes the RFID antenna 44 to receive the transmit signal from the wireless tag reading apparatus 30 with respect to the reader and writer unit 46. In addition, the radio wave transmission and reception unit 80 causes the RFID antenna 44 to transmit the response signal including the identification number I of the RFID tag T with respect to the reader and writer unit 46.

Upon receipt of the transmit signal from the wireless tag reading apparatus 30, the activation control unit 82 activates the RFID tag T. In addition, the activation control unit 82 stops the RFID tag T from being activated.

The identification number reading unit 84 reads the identification number I registered in the RFID tag T from the storage unit 42 described above.

The reading completion information writing unit 86 writes information indicating that the identification number I of the RFID tag T is read, on the RFID tag T in which the identification number I is registered.

### Description of Setting Method of Reading Range

Next, a method of setting the reading range of the RFID tag T read by the wireless tag reading apparatus 30 will be described.

When the high-frequency signal (radio wave) propagates through the air, the wavelength becomes shorter as the frequency becomes higher. Therefore, when the distance between the RFID antenna 22 and the RFID tag T is the same, the response signal is detected in a different phase when communicating with a high-frequency signal having a different wavelength. In other words, in the wireless tag reading apparatus 30, the phase of the response signal detected when communicating with the RFID tag T using a first frequency f1 and the phase of the response signal detected when communicating with the RFID tag T using a second frequency f2 different from the first frequency f1 are different from each other.

As the distance between the RFID antenna 22 and the RFID tag T increases, the phase difference changes. The degree of the change in the phase difference depends on the frequency difference between the first frequency f1 and the second frequency f2. Specifically, when the frequency difference between the first frequency f1 and the second frequency f2 is small, that is, when the wavelength difference is small, a region having the same phase difference does not occur unless the RFID antenna 22 and the RFID tag T are separated by a certain distance. On the other hand, when the frequency difference between the first frequency f1 and the second frequency f2 is large, that is, when the wavelength difference is large, there occurs a region having the same phase difference with respect to a slight change in the distance between the RFID antenna 22 and the RFID tag T.

As such, by setting the frequency difference between the first frequency f1 and the second frequency f2 to be relatively small, when a response signal is received from the RFID tag T placed within the predetermined distance range from the RFID antenna 22, the phase difference in a specific region between the phase of the response signal of the first frequency f1 and the phase of the response signal of the second frequency f2 is equal to or less than a predetermined threshold Δω.

How small the frequency difference between the first frequency f1 and the second frequency f2 is to be set may be determined based on the first frequency f1, the second frequency f2, and the read range of the RFID tag T to be used. More specifically, when the high-frequency signals of different frequencies f1 and f2 are transmitted to the RFID tag T attached to the commodity M in the shopping basket 12 placed within the reading range 32 (see FIG. 1), the first frequency f1 and the second frequency f2 are selected so that the phase difference of the response signal acquired is equal to or less than a predetermined threshold Δω. In addition, the intensity of the transmitted radio wave is set to the intensity at which the RFID tag T is activated by the transmitted radio wave within a range where the phase difference equal to or less than the predetermined threshold Δω is detected. Specifically, the amplification factor of the amplifier 72 is set so that the RFID tag T is activated, within a range where a phase difference equal to or less than a predetermined threshold Δω is detected.

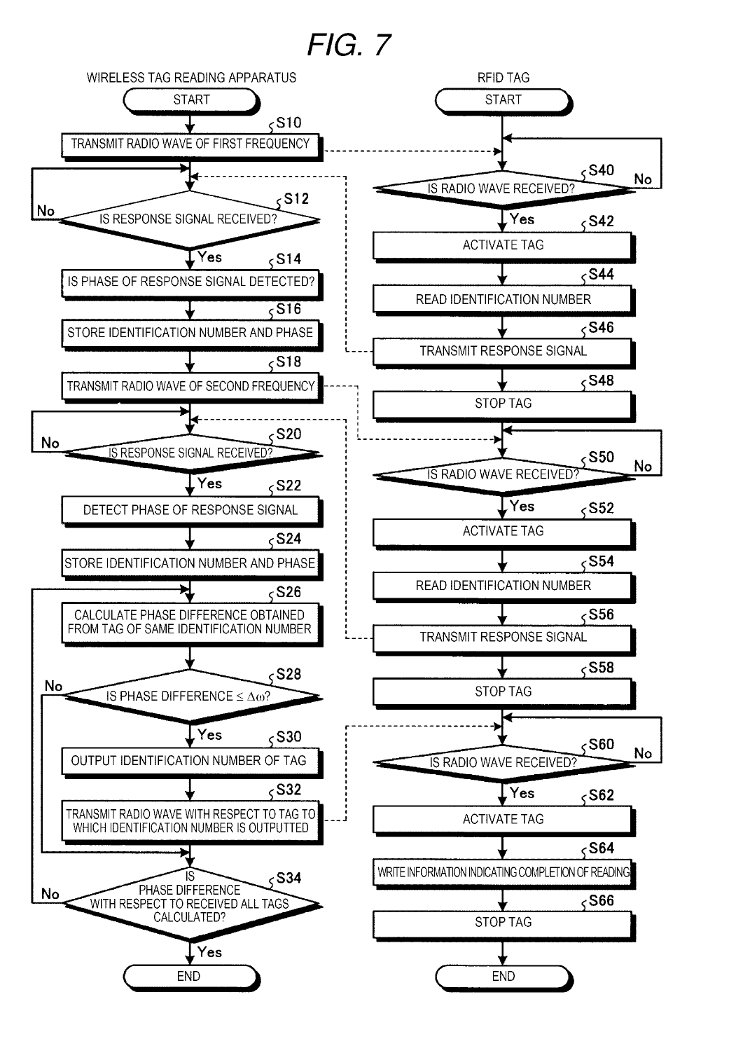

Next, the setting of the reading range of the RFID tag T will be described in more detail with reference to FIG. 6. FIG. 6 is a view taken in the direction of the arrow A in FIG. 1, provided for explaining the reading range of the RFID tag T. As shown in FIG. 6, regions where the phase difference between the phase of the response signal of the first frequency f1 and the phase of the response signal of the second frequency f2 is equal to or less than the predetermined threshold Δω periodically appear as in the case of the regions R1 and R3. Here, the regions R1 and R3 are regions surrounded by a substantially spherical surface having a constant distance from the RFID antenna 22. Then, the wireless tag reading apparatus 30 sets only the region R1 closest to the RFID antenna 22 as the reading range. In the region R2 sandwiched between the region R1 and the region R3, the phase difference between the phase of the response signal of the first frequency f1 and the phase of the response signal of the second frequency f2 is larger than a predetermined threshold Δω. Although not shown in FIG. 6, since the transmit signal radiated by the RFID antenna 22 is propagated as a wave, even in the region outside the region R3, the region where the phase difference is equal to or less than a predetermined threshold Δω appears periodically.

In addition, in the wireless tag reading apparatus 30, the region where the intensity of the transmit signal radiated by the RFID antenna 22 is equal to or larger than a predetermined value, has a shape that expands toward the direction of the directivity of the RFID antenna 22 as the region Q1 shown in FIG. 6, for example. That is, only the RFID tag T in the region Q1 may be activated by receiving the transmit signal from the RFID antenna 22. That is, the RFID tag T in the region S1, which is the region where the region R1 and the region Q1 overlap with each other, is activated by receiving the transmit signal radiated by the RFID antenna 22. Further, in the RFID tag T in the region S1, the phase difference between the phase of the response signal of the first frequency f1 and the phase of the response signal of the second frequency f2 is equal to or less than a predetermined threshold Δω. As a result, it is possible to set the region S1 to a range in which the identification number I of the RFID tag T can be read. As shown in FIG. 6, this region S1 is set to include the shopping basket 12 placed within the reading range 32.

That is, when the RFID tag T is located outside the region S1, the wireless tag reading apparatus 30 does not read the identification number I of the RFID tag T. For example, in FIG. 6, in the case where the RFID tag T is within the region R2, when the RFID tag T is located within the region Q1, the RFID tag T is activated, but the phase difference is larger than the predetermined threshold Δω. Therefore, the wireless tag reading apparatus 30 does not read the identification number I of the RFID tag T. In addition, when the RFID tag T is located outside the region Q1, the RFID tag T is not activated, so the wireless tag reading apparatus 30 does not read the identification number I of the RFID tag T.

In addition, in FIG. 6, in the case where the RFID tag T is within the region R3, the RFID tag T is not activated, so the wireless tag reading apparatus 30 does not read the identification number I of the RFID tag T.

It is assumed that the intensity of the transmit signal radiated by the RFID antenna 22 is increased and the region Q1 described above overlaps with the region R3. In this case, when the RFID tag T is present at both positions belonging to the region Q1 and the region R3, the RFID tag T is activated upon reception of the transmit signal. Then, the phase difference becomes equal to or less than a predetermined threshold Δω. Therefore, in this case, the wireless tag reading apparatus 30 reads the identification number I of the RFID tag T. In order to prevent this, it is necessary to adjust the intensity of the transmit signal radiated by the RFID antenna 22 so that the region Q1 and the region R3 do not overlap with each other. Conversely, the intensity of the transmit signal radiated by the RFID antenna 22 may increase to a range where the region Q1 does not overlap with the region R3. As a result, the radio wave intensity in the region S1 which is the original reading range can be increased, so that the reading accuracy of the RFID tag T can be improved.

### Description of Flow of Process Performed by Wireless Tag Reading Apparatus

Next, the flow of process performed by the wireless tag reading apparatus 30 will be described with reference to FIG. 7. FIG. 7 is a flowchart showing an example of a flow of a process performed by a wireless tag reading apparatus 30.

The process at the wireless tag reading apparatus 30 is performed with a cooperation between the RFID tag T and the wireless tag reading apparatus 30 side. First, the flow of process on the wireless tag reading apparatus 30 side will be described. First, the radio wave transmission unit 50 causes the RFID antenna 22 to transmit radio waves having the first frequency f1 (Act 10).

Next, the radio wave reception unit 52 determines whether or not the response signal is received (Act 12). When it is determined that the response signal is received (Act 12: Yes), the process proceeds to Act 14. On the other hand, when it is determined that the response signal is not received (Act 12: No), the determination in Act 12 is repeated. Although not shown in FIG. 7, when the response signal is not received over a predetermined time, it is determined that the RFID tag T to be read is not present, and the process in FIG. 7 is ended.

Next, in Act 14, the phase detection unit 58 detects the phase of the response signal. Then, in Act 16, the tag information reading unit 62 reads the identification number I included in the received response signal and stores the read identification number I in the storage unit 34 together with the phase.

Next, the radio wave transmission unit 50 causes the RFID antenna 22 to transmit radio waves having the second frequency f2 (Act 18).

The radio wave reception unit 52 determines whether or not the response signal is received (Act 20). When it is determined that the response signal is received (Act 20: Yes), the process proceeds to Act 22. On the other hand, when it is determined that the response signal is not received (Act 20: No), the determination in Act 20 is repeated. Although not shown in FIG. 7, when the response signal is not received over the predetermined time, it is determined that the RFID tag T to be read does not present, and the processing in FIG. 7 is ended.

Next, in Act 22, the phase detection unit 58 detects the phase of the response signal. Then, in Act 24, the tag information reading unit 62 reads the identification number I included in the received the response signal and stores the read identification number I in the storage unit 34 together with the phase.

Although not shown in FIG. 7, since there are generally a plurality of RFID tags T, the process from Act 12 to Act 16 and the process from Act 20 to Act 24 are performed and repeatedly performed by the number of the RFID tags T present within the reading range 32.

In Act 26, the phase difference calculation unit 60 calculates the phase difference of the phase acquired from the RFID tag T having the same identification number I. That is, when the response signal having identification number I is acquired only as a response signal to the transmit signal of the first frequency f1, or only as a response signal to the transmit signal of the second frequency number f2, the RFID tag T having the identification number I is excluded from the reading target.

Subsequently, the phase difference calculation unit 60 determines whether the calculated phase difference is equal to or less than a predetermined threshold Δω (Act 28). When it is determined that the calculated phase difference is equal to or less than the predetermined threshold Δω (Act 28: Yes), the process proceeds to Act 30. On the other hand, when it is determined that the calculated phase difference is not equal to or less than the predetermined threshold Δω (Act 28: No), the process proceeds to Act 34.

Next, in Act 30, the information determination unit 64 outputs the identification number I of the RFID tag T.

Subsequently, the radio wave transmission unit 50 causes the RFID antenna 22 to transmit the radio wave by designates the RFID tag T from which the identification number I is read as the reception destination (Act 32). At this time, the frequency of the radio waves to be transmitted does not have to be frequencies f1 and f2, but may be any available frequency.

The phase difference calculation unit 60 determines whether or not the phase difference is calculated for all the received RFID tags T (Act 34). When it is determined that the phase difference is calculated for all the received RFID tags T (Act 34: Yes), the process in FIG. 7 is ended. On the other hand, when it is determined that the phase difference is not calculated for all the received RFID tags T (Act 34: No), the process returns to Act 26.

Next, the flow of process on the RFID tag T side will be described. First, the radio wave transmission and reception unit 80 determines whether or not the RFID antenna 44 receives radio waves having the first frequency f1 (Act 40). When it is determined that the radio wave is received (Act 40: Yes), the process proceeds to Act 42. On the other hand, when it is determined that the radio wave is not received (Act 40: No), Act 40 is repeated.

At Act 42, the activation control unit 82 activates the RFID tag T. At Act 44, the identification number reading unit 84 reads the identification number I of the RFID tag T.

Subsequently, at Act 46, the radio wave transmission and reception unit 80 causes the RFID antenna 44 to transmit the response signal including the identification number I. Thereafter, at Act 48, the activation control unit 82 stops the operation of the RFID tag T.

Next, the radio wave transmission and reception unit 80 determines whether or not the RFID antenna 44 receives radio waves having the second frequency f2 (Act 50). When it is determined that the radio wave is received (Act 50: Yes), the process proceeds to Act 52. On the other hand, when it is determined that the radio wave is not received (Act 50: No), Act 50 is repeated.

In Act 52, the activation control unit 82 activates the RFID tag T. At Act 54, the identification number reading unit 84 reads the identification number I of the RFID tag T.

Subsequently, at Act 56, the radio wave transmission and reception unit 80 causes the RFID antenna 44 to transmit the response signal including the identification number I. Thereafter, at Act 58, the activation control unit 82 stops the operation of the RFID tag T.

Next, the radio wave transmission and reception unit 80 determines whether or not the RFID antenna 44 receives radio waves (Act 60). When it is determined that the radio wave is received (Act 60: Yes), the process proceeds to Act 62. On the other hand, when it is determined that the radio wave is not received (Act 60: No), Act 60 is repeated.

At Act 62, the activation control unit 82 activates the RFID tag T. Then, the reading completion information writing unit 86 writes information indicating that reading of the identification number I is completed to the RFID tag T (Act 64). Thereafter, at Act 66, the activation control unit 82 stops the operation of the RFID tag T, and ends the process in FIG. 7.

As described above, in the wireless tag reading apparatus 30 according to the first embodiment, the response signal of the RFID tag T (wireless tag) for signals of the first frequency f1 and the second frequency f2 different from each other transmitted by the radio wave transmission unit 50 (radio wave transmitting means) is received by the radio wave reception unit 52 (radio wave receiving means). Then, the phase difference calculation unit 60 (phase difference calculating means) calculates the phase difference of a plurality of response signals received by the radio wave reception unit 52. The information determination unit 64 (information determining means) selects the RFID tag T from which the identification number I (identification information) is to be read based on the calculated phase difference. Then, the tag information reading unit 62 (tag information reading means) reads the identification number I (identification information) registered in the selected RFID tag T. Therefore, it is possible to read the identification number I registered in the RFID tag T in a predetermined region without accommodating the RFID tag T in a storage chamber that shields radio waves.

In addition, in the wireless tag reading apparatus 30 according to the first embodiment, the information determination unit 64 excludes the RFID tag T from the reading target, under a condition that in the tag information reading unit 62, the response signals with respect to all the signals of a plurality of frequencies transmitted by the radio wave transmission unit 50 do not include a response signal acquired from the same RFID tag T. Therefore, it is possible to reliably read the identification number I registered in the RFID tag T.

In addition, in the wireless tag reading apparatus 30 according to the first embodiment, the information determination unit 64 selects an RFID tag T to be read by the tag information reading unit 62 under a condition that the phase difference calculated by the phase difference calculation unit 60 be equal to or less than a predetermined threshold value Δω. Therefore, it is possible to read only the identification number I registered in the RFID tag T within the predetermined region S1.

In the wireless tag reading apparatus 30 according to the first embodiment, the radio wave transmission unit 50 sets the intensity of the radio wave to be transmitted to at least the intensity at which the RFID tag T placed within the predetermined region S1 is activated. Therefore, since it is possible to reliably activate the RFID tag T within at least the predetermined region S1, it is possible to reliably read the identification number I registered in the RFID tag T in the region S1. The intensity of the radio wave radiated by the RFID antenna 22 can be increased to a condition that the RFID tag T within the region R3 (see FIG. 6) is not activated. As a result, since the intensity of the radio wave in the region S1 can be maximized, the reading accuracy of the identification number I registered in the RFID tag T can be improved.

### Modification Example of the First Embodiment

Next, a wireless tag reading apparatus 30a (not shown) which is a modification example according to the first embodiment will be described. The wireless tag reading apparatus 30a has the same hardware configuration (see FIG. 3) and the same functional configuration (see FIGS. 4 and 5) as the wireless tag reading apparatus 30 described in the first embodiment. Then, in the first embodiment, a radio wave of the second frequency f2 is transmitted to all the RFID tags T, and the modification example of the first embodiment is different from the first embodiment in that radio wave of the second frequency f2 are transmitted only to the RFID tag T that returns the response signal to the transmit signal of the first frequency f1. In the following description, the constituent components of the wireless tag reading apparatus 30a are expressed using the same reference numerals as those of the wireless tag reading apparatus 30.

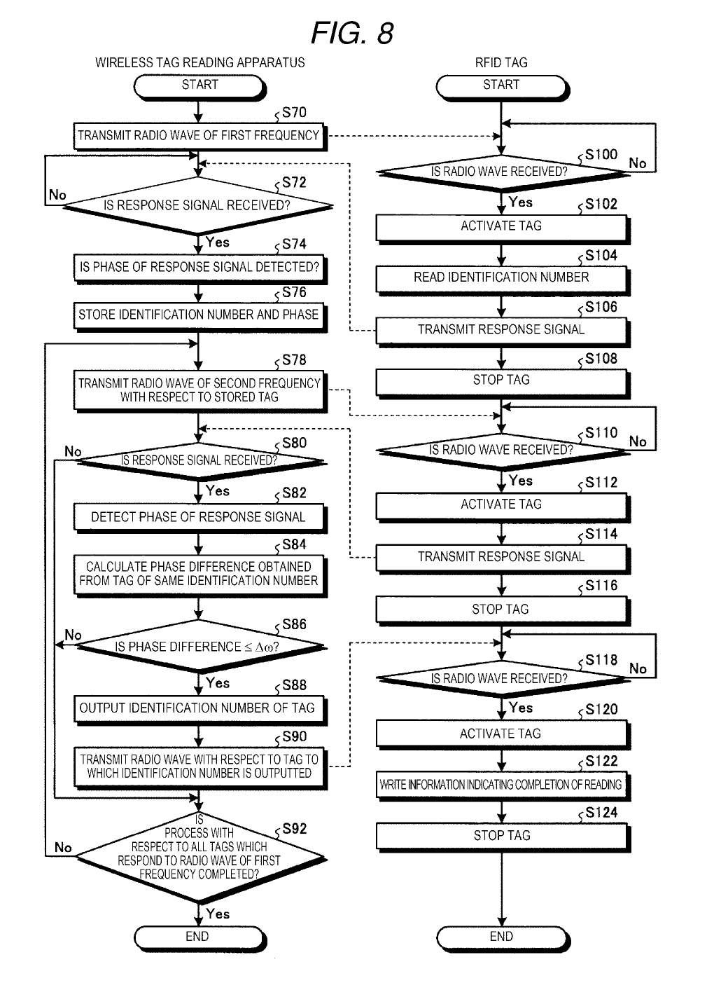

Hereinafter, the flow of the process performed by the wireless tag reading apparatus 30a will be described with reference to FIG. 8. FIG. 8 is a flowchart showing an example of a flow of a process performed by a wireless tag reading apparatus 30a according to a modification example of the first embodiment.

First, the flow of the process at the wireless tag reading apparatus 30a side will be described. The same process as in the first embodiment is performed until the transmit signal of the first frequency f1 is transmitted to the RFID tag T and the response signal from the RFID tag T is received (Acts 70, 72, 74, and 76).

Next, at Act 78, the radio wave transmission unit 50 designates the RFID tag T storing the identification number I as a destination of the transmission, and causes the RFID antenna 22 to transmit the radio wave of the second frequency f2.

Subsequently, at Act 80, the radio wave reception unit 52 determines whether or not the response signal is received. When it is determined that the response signal is received (Act 80: Yes), the process proceeds to Act 82. On the other hand, when it is determined that the response signal is not received (Act 80: No), the process proceeds to Act 92. Although not shown in FIG. 8, when the response signal is not received over a predetermined time at Act 80, it is determined that there is no RFID tag T to be read, and the process in FIG. 8 is ended.

Next, at Act 82, the phase detection unit 58 detects the phase of the response signal. At Act 84, the phase difference calculation unit 60 calculates the phase difference of the phase acquired from the RFID tag T having the same identification number I.

Subsequently, the phase difference calculation unit 60 determines whether the calculated phase difference is equal to or less than a predetermined threshold Δω (Act 86). When it is determined that the calculated phase difference is equal to or less than the predetermined threshold Δω (Act 86: Yes), the process proceeds to Act 88. On the other hand, when it is determined that the calculated phase difference is not equal to or less than the predetermined threshold Δω (Act 86: No), the process proceeds to Act 92.

Next, at Act 88, the information determination unit 64 outputs the identification number I of the RFID tag T.

Subsequently, the radio wave transmission unit 50 causes the RFID antenna 22 to transmit the radio wave by designating the RFID tag T from which the identification number I is read as the reception destination (Act 90). At this time, the frequency of the radio waves to be transmitted need not to be the frequencies f1 and f2, but may be any usable frequency.

The phase difference calculation unit 60 determines whether or not process for all the RFID tags T in response to the radio wave of the first frequency f1 is completed (Act 92). When it is determined that the process for all the RFID tags T in response to the radio wave of the first frequency f1 is completed (Act 92: Yes), the process in FIG. 8 is ended. On the other hand, when it is determined that the processing for all RFID tags T in response to the radio wave of the first frequency f1 is not completed (Act 92: No), the process returns to Act 78.

Next, the flow of the process on the RFID tag T side will be described. The RFID tag T is activated by receiving the radio wave of the first frequency f1 transmitted by the wireless tag reading apparatus 30a at Act 70 and stops the operation after transmitting the response signal carrying the identification number I registered in each RF ID tag T. The flow of the processing of this part is the same as described in the first embodiment (Acts 100, 102, 104, 106, and 108).

Then, the radio wave transmission and reception unit 80 of the RFID tag T determines whether or not the RFID antenna 44 receives radio waves having the second frequency f2 (Act 110). When it is determined that the radio wave is received (Act 110: Yes), the process proceeds to Act 112. On the other hand, when it is determined that the radio wave is not received (Act 110: No), Act 110 is repeated.

At Act 112, the activation control unit 82 activates the RFID tag T. At Act 114, the radio wave transmission and reception unit 80 causes the RFID antenna 44 to transmit the response signal. Thereafter, at Act 116, the activation control unit 82 stops the operation of the RFID tag T.

Subsequently, the RFID tag T is activated by receiving the radio wave transmitted by the wireless tag reading apparatus 30a at Act 90, stops the operation after writing information indicating completion of reading, stops the operation, and ends the processing in FIG. 8. The flow of the process in this part will be referenced to the description of the first embodiment (Acts 118, 120, 122, and 124).

As described above, in the wireless tag reading apparatus 30a according to the modification example of the first embodiment, the radio wave transmission unit 50 transmits the signal of the second frequency f2 only to the RFID tag T that has the identification information I, based on the identification number I of the RFID tag T included in the response signal with respect to the transmitted signal of the first frequency f1. Therefore, it is possible to identify the RFID tag T to be read with a smaller calculation amount.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the frequency of radio waves to be used is not limited to two kinds only. That is, each of the embodiments described above may be realized by using transmit signals of three or more different frequencies f1, f2, and f3. In this case, when all three phase differences acquired by comparing two optional response signals among the response signals of the three frequencies are equal to or less than a predetermined threshold Δω, the identification number I registered in the RFID tag T may be read.

In addition, in the embodiment and its modification example described above, there is no restriction on the magnitude relationship between the first frequency f1 and the second frequency f2. In other words, either of f1<f2 or f1>f2 may be applied.

What is claimed is:

1. A wireless tag reading apparatus that reads identification information registered in a wireless tag, comprising:
a plurality of radio wave transmitters for transmitting a plurality of signals having different frequencies from each other;
a radio wave receiver for receiving a response signal of the wireless tag which is activated by receiving a signal transmitted by the radio wave transmitter;
a phase difference calculating component for calculating a phase difference between a plurality of the response signals received by the radio wave receiver;
an information determining component for selecting a wireless tag from which the identification information is to be read based on the phase difference calculated by the phase difference calculating component; and
a tag information reader for reading the identification information registered in the wireless tag selected by the information determining component.

2. The apparatus according to claim 1,
wherein the radio wave transmitter transmits a signal of a second frequency only to a wireless tag having identification information of a wireless tag included in the response signal with respect to a transmitted signal of a first frequency based on the identification information.

3. The apparatus according to claim 1,
wherein the information determining component excludes a wireless tag from a reading target, under a condition that in the tag information reader, response signals to all the signals of a plurality of frequencies transmitted by the radio wave transmitter do not include a response signal from the same wireless tag.

4. The apparatus according to claim 1,
wherein the information determining component selects a wireless tag to be read by the tag information reader under a condition that the phase difference calculated by the phase difference calculating component is equal to or less than a predetermined threshold.

5. The apparatus according to claim 1,
wherein the radio wave transmitter sets an intensity of a radio wave to be transmitted to at least an intensity at which the wireless tag placed within the predetermined region is activated.

6. The apparatus according to claim 1,
wherein the radio wave receiver receives identification information of the wireless tag.

7. The apparatus according to claim 1,
wherein calculating the phase difference is conducted using orthogonal demodulation techniques.

8. The apparatus according to claim 1,
wherein the wireless tag is an RFID tag.

9. A wireless tag reading method for reading identification information registered in a wireless tag, comprising:
transmitting a plurality of signals of different frequencies from each other;
receiving a response signal of the wireless tag which is activated by receiving a signal transmitted in the transmitting;
calculating a phase difference between a plurality of response signals received in the receiving;
selecting a wireless tag from which the identification information is to be read based on the phase difference calculated in the calculating; and
reading identification information registered in the wireless tag selected in the selecting.

10. The wireless tag reading method according to claim 9,
wherein the radio wave transmitter transmits a signal of a second frequency only to a wireless tag having identification information of a wireless tag included in the response signal with respect to a transmitted signal of a first frequency based on the identification information.

11. The wireless tag reading method according to claim 9,
wherein the information determining component excludes a wireless tag from a reading target, under a condition that in the tag information reader, response signals to all the signals of a plurality of frequencies transmitted by the radio wave transmitter do not include a response signal from the same wireless tag.

12. The wireless tag reading method according to claim 9,
wherein the information determining component selects a wireless tag to be read by the tag information reader under a condition that the phase difference calculated by the phase difference calculating component is equal to or less than a predetermined threshold.

13. The wireless tag reading method according to claim 9,
wherein the radio wave transmitter sets an intensity of a radio wave to be transmitted to at least an intensity at which the wireless tag placed within the predetermined region is activated.

14. The wireless tag reading method according to claim 9,
wherein the radio wave receiver receives identification information of the wireless tag.

15. The wireless tag reading method according to claim 9,
wherein calculating the phase difference is conducted using orthogonal demodulation techniques.

16. A POS terminal, comprising:
a plurality of radio wave transmitters for transmitting a plurality of signals having different frequencies from each other;
a radio wave receiver for receiving a response signal of a wireless tag which is activated by receiving a signal transmitted by the radio wave transmitter;
a phase difference calculating component for calculating a phase difference between a plurality of the response signals received by the radio wave receiver;
an information determining component for selecting a wireless tag from which the identification information is to be read based on the phase difference calculated by the phase difference calculating component;
a tag information reader for reading identification information registered in the wireless tag selected by the information determining component;
a receipt module for generating a receipt.

17. The POS terminal according to claim 16,
wherein the radio wave transmitter transmits a signal of a second frequency only to a wireless tag having identification information of a wireless tag included in the response signal with respect to a transmitted signal of a first frequency based on the identification information.

18. The POS terminal according to claim 16,
wherein the information determining component excludes a wireless tag from a reading target, under a condition that in the tag information reader, response signals to all the signals of a plurality of frequencies transmitted by the radio wave transmitter do not include a response signal from the same wireless tag.

19. The POS terminal according to claim 16,
wherein the information determining component selects a wireless tag to be read by the tag information reader under a condition that the phase difference calculated by the phase difference calculating component is equal to or less than a predetermined threshold.

20. The POS terminal according to claim 16,
wherein the radio wave transmitter sets an intensity of a radio wave to be transmitted to at least an intensity at which the wireless tag placed within the predetermined region is activated.
